(19) United States
(12) Patent Application Publication
(10) Pub. No.: US 2022/0416494 A1
(43) Pub. Date: Dec. 29, 2022

(54) Side-pumped solid-state disk laser for high gain

(71) Applicant: David M. Filgas, Newbury Park, CA (US)

(72) Inventor: David M. Filgas, Newbury Park, CA (US)

(73) Assignee: David M. Filgas

(21) Appl. No.: 16/974,221

(22) Filed: Nov. 18, 2020

(51) Int. Cl. H01S 3/02; H01S 3/042; H01S 3/06; H01S 3/0941; H01S 3/04

(52) U.S. Cl. CPC H01S 3/025; H01S 3/042; H01S 3/0604; H01S 3/09415; H01S 3/0405

(57) ABSTRACT

A solid state laser module for amplification of laser radiation including a laser gain medium disk. The disk has a pair of generally parallel surfaces that receive, reflect, or transmit laser radiation. At least one perimetral optical medium is disposed adjacent a peripheral edge of the laser gain medium disk and in optical communication therewith. A source of optical pump radiation directs optical pump radiation through the perimetral optical medium and into the laser gain medium disk to pump the laser gain medium to produce optical gain at the laser wavelength. A dichroic beam splitter is located between the optical pump source and the perimetral optical medium to prevent amplified spontaneous emission generated within the laser gain medium from illuminating the source of optical pump radiation.

### CROSS-REFERENCE TO RELATED APPLICATIONS

This application claims priority from the U.S. provisional patent application U.S. Ser. No. 62/974,214, filed on Nov. 18, 2019 and entitled “Side-Pumped Solid-State Disk Laser for High Gain”.

### GOVERNMENT RIGHTS IN THIS INVENTION

This invention was made with U.S. Government support wider the U.S. Department of Energy Grant No. DE-SC0015834. The U.S. Government may have certain rights in this invention.

### FIELD OF THE INVENTION

The present invention relates to solid-state lasers and more particularly to a solid-state disk laser capable of generating high gain or the like.

### BACKGROUND OF THE INVENTION

Solid-state disk lasers and the like are being used in many new applications. Examples of such applications may include but are not necessarily limited to scientific instrumentation, military laser target illuminators or designators, and commercial laser material processing applications such as cutting, welding, drilling, additive manufacturing, or the like.

In a solid-state disk laser or the like, high gain is critical to generating high-pulse energies and achieving operation at high-average power in a compact package. One challenge to developing solid-state lasers delivering high-pulse energy and/or high-average power is a limitation on the laser gain imposed by losses caused by amplified spontaneous emission (ASE). ASE is a phenomenon wherein spontaneously emitted photons traverse the laser gain medium (LGM) and are amplified before they may exit the LGM. The favorable condition for ASE is a combination of high gain and a long path of travel inside the LGM for the spontaneously emitted photons. Reflection from the LGM boundaries or from external objects back into the LGM increases the path through the high gain material and may further amplify the ASE.

ASE may depopulate the upper energy level in an excited laser gain medium, thereby reducing laser gain, robbing the laser of extractable power and limiting the laser's efficiency. In extreme cases, reflections at the LGM boundaries may also provide feedback for parasitic laser oscillations that greatly aggravate the loss of laser power. In addition, power lost to ASE may be deposited as heat in various parts of the laser system, causing thermally driven dimensional changes, thermal stress with possible consequences including misalignment of optical components, optical path variations and instability, reduction of laser beam quality, and the like. In high-average power lasers, ASE losses and concomitant heating can amount to several kilowatts of power. In pulsed lasers ASE losses may delay the laser pulse startup thereby wasting power in excited laser states. If unchecked, ASE may become large enough to significantly deplete the upper level inversion in high-gain laser pulsed amplifiers.

One traditional method for reducing ASE losses to an acceptable level is disclosed, for example, by Powell et al. in U.S. Pat. No. 4,849,036. This method involves cladding selected surfaces of the laser gain medium with a material that can efficiently absorb ASE radiation. To reduce the reflection of ASE rays at the cladding junction, the cladding material must have an index of refraction at the laser wavelength that is closely matched to that of the laser gain medium. Another method for reduction of ASE losses is disclosed by Zapata et al. in the U.S. Pat. No. 5,335,237 entitled “Parasitic Oscillation Suppression in Solid State Lasers Using Absorbing Thin Films” involves an ASE absorption coating. Yet another method for reduction of ASE losses involves shaping the LGM geometry to channel ASE rays out of the LGM as disclosed by J. Vetrovec et al. in the U.S. Pat. No. 7,477,674. However, the practicality of implementing ASE mitigation in accordance with the prior art is strongly influenced by the nature and specific configuration of the solid-state LGM and its operation.

One configuration of solid-state LGM conducive to generating high-pulse energies and operation at high-average power is known as the disk laser. An advanced concept for delivering optical pump into the disk laser is known as “side pumping.” In technical literature, side pumping may also be referred to as “edge pumping.” The side pumped solid-state laser disk is disclosed by J. Vetrovec in U.S. Pat. No. 6,625,193 issued on Sep. 23, 2003, the entire disclosure of which is incorporated herein by reference.

In the side-pumped laser disk, ASE originating in the doped (lasing) portion of the side-pumped laser disk (laser gain medium) is largely confined to between the large faces of the laser disk by total internal reflection (TIR) and generally stream out radially toward the optical pump sources placed around the disk perimeter. This may cause deleterious optical feedback to the pump sources, which may cause their degradation or even a failure. In addition, there is a possible reflection of the ASE from the optical pump sources back into the laser gain medium, which would lead to further ASE amplification and possibly provide a feedback to parasitic lasing. Other components around the laser disk perimeter may be irradiated by the ASE and experience a heat load. The subject invention overcomes these limitations of the referenced prior art.

The side-pumped disk laser offers efficient operation of the laser, very uniform laser gain across the laser lasing aperture, and laser modularization into compact, self-contained units. Side pumping also beneficially provides a long absorption path for the optical pump, which allows reduction of doping in the host material by laser ions. This curbs upconversion and excited state absorption. In a quasi-3-level LGM, the reduction in laser ion doping makes it easier to overcome the ground-state absorption at the laser wavelength, thus reducing laser threshold and waste heat. Thermal conductivity of many important crystal and ceramic host materials is substantially reduced with increased level of doping by laser ions. In contrast, the low doping afforded by the side-pumping architecture may retain much of the thermal conductivity of the host material. For general discussion of side-pumped disk lasers see, for example, J. Vetrovec et al., “Initial testing of edge-pumped Yb:YAG disk laser with multi-passed extraction,” published in SPIE volume 8235 in 2012; J. Vetrovec, et al., “Yb:YAG Ceramic-Based Laser Driver for Inertial Fusion Energy (IFE),” published in SPIE volume 9726 in 2016; and J. Vetrovec, et al., “The Development of a 5-cm Aperture Ceramic Yb:YAG Edge-Pumped Disk Laser Amplifier,” published in SPIE volume 10898 in 2019.

### SUMMARY OF THE INVENTION

In view of the foregoing limitations with previously developed side-pumped disk lasers, it is an object of the present invention to provide a solid-state side pumped disk laser capable of operating at high-average power and delivering laser pulses with high-pulse energy. In particular, the subject invention provides means for reducing, mitigating, and/or outcoupling of ASE.

It is well known that solid-state LGM may be pumped by optical pump radiation at a pump wavelength to produce an optical gain at a laser wavelength. Generally, the laser wavelength is longer that the pump wavelength. ASE is generally an optical radiation with a spectral band in the vicinity of the laser wavelength. For example, trivalent ytterbium-doped yttrium aluminum garnet (Yb³⁺:YAG) LGM may be pumped at either of its two pump wavelengths, namely 940 nm or at 980 nm, and lased in the vicinity of the 1030 nm wavelength.

In one embodiment of the subject invention, a dichroic beam splitter is installed at approximately a 45 degree angle between the optical pump source and the edge of the laser disk. A dichroic beam splitter is an optical component having one or more surfaces equipped with a wavelength-selective optical coating. In this particular embodiment, the beam splitter is arranged to be highly transmissive at the wavelength of the optical pimp source and highly reflective at the ASE wavelength at the deployed angle of incidence. As a result, optical pumping radiation passes through the beam splitter and is generally unaffected by it. However, the ASE emanating from the perimetral surface of the disk is reflected by the beam splitter at about 90 degrees from the optical axis of the optical pump and it is directed onto an absorber. This arrangement has several key advantages: 1) it protects the optical pump source from optical load by the ASE, 2) it prevents possible reflection of the ASE from the surfaces of the optical pump source (or other components around the disk perimeter) back into the laser gain medium, and 3) it allows for safe neutralization of ASE on the absorber.

In another embodiment of the subject invention the optical pump is delivered into the disk by a reflection from a dichroic beam splitter positioned at about a 45 degree angle with respect to the disk perimetral surface. In this particular embodiment, the beam splitter is arranged to be highly reflective at the wavelength of the optical pump source and highly transmissive at the ASE wavelength at the deployed angle of incidence.

In yet another embodiment of the subject invention, the function of dichroic beam splitter is incorporated into a collimating lens of the optical pump source. In particular, the convex surface of the collimating lens facing the laser disk assembly is equipped with a dichroic coating, that is transmissive at the wavelength of the optical pump source and highly reflective the wavelength band of the ASE radiation.

In a further embodiment of the subject invention, gas cooling may be applied to remove waste heat from the laser disk. In a yet further embodiment of the subject invention, waste heat is removed from the laser disk by conduction to a heat sink.

Other aspects and features of the present invention, as defined solely by the claims, will become apparent to those ordinarily skilled in the art upon review of the following non-limited detailed description of the invention in conjunction with the accompanying figures. In addition, various references are set forth herein, including in the Cross-Reference to Related Applications, that discuss certain systems, apparatus, methods and other information; all such references are incorporate herein by reference in their entirety and for all their teachings and disclosures, regardless of where the references may appear in this application.

### BRIEF DESCRIPTION OF THE DRAWINGS

FIG. 1 is an exemplary isometric view of a side-pumped disk laser module of the subject invention using a direct injection of pump light into the disk edge.

FIG. 2 is a cross-sectional view 2-2 of the side-pumped disk laser module of FIG. 1.

FIG. 3 is and enlarged view 3-3 of the side-pumped disk laser module of FIG. 2.

FIG. 4 is a cross-sectional view of an alternative LGM assembly having a uniform thickness.

FIG. 5 is a cross-sectional view of another alternative LGM assembly comprising solely of the LGM.

FIG. 6 is a cross-sectional view of a side-pumped disk laser of the subject invention using a reflective injection of pump light into the disk edge and cooled by a heat sink.

FIG. 7 is a cross-sectional view of a side-pumped disk laser of the subject invention in accordance with yet another alternative preferred embodiment suitable for even more compact packaging.

### DETAILED DESCRIPTION OF THE PREFERRED EMBODIMENTS

As used herein, “Laser gain medium” or “LGM” may refer to an optical material having a host lattice doped with suitable ions, which may be pumped by an external source of optical pump radiation to produce optical gain at a laser wavelength. Examples of host lattice material that may be used in conjunction with the present invention may include yttrium aluminum garnet (YAG), gadolinium gallium garnet (GGG), gadolinium scandium gallium garnet (GSGG), lithium yttrium fluoride (YLF), lutetium sesquioxide (Lu₂O₃), yttrium sesquioxide (Y₂O₃), scandium sesquioxide (Sc₂O₃), yttrium vanadate, phosphate laser glass, silicate laser glass, sapphire, or similar materials. The host material may be in a single crystal form or in a poly-crystalline (ceramic) form. Suitable dopants (laser ions) for Such LGM may include titanium (Ti), neodymium (Nd), holmium (Ho), erbium (Er), thulium (Tm), ytterbium (Yb), dysprosium (Dy), praseodymium (Pr), samarium (Sm), europium (Eu), copper (Cu), cobalt (Co), nickel (Ni), chromium (Cr), cesium (Ce), gadolinium (Gd), and terbium (Tb). Optical pump sources may be selected based on the absorption characteristics of the selected laser gain medium. For example, semiconductor diode lasers may be used for the optical pump source. The present invention is not intended to be limited to any specific lasing Or laser gain material, or a specific optical pump source.

“Undoped optical medium” refers to an optical material which is preferably substantially free of substances that can absorb optical pump radiation. Preferably, the undoped medium is of the same host material as the LGM but it is not doped. However, in some variants of the invention, undoped optical medium may be slightly doped with ions which may absorb optical radiation at the wavelengths of the optical pump and/or the laser gain transition, but may not by sufficiently pumped to produce optical gain.

Undoped optical medium may be attached (bonded) to the peripheral surface of the LGM by a fusion bond, or diffusion bond, or other suitable means depending on the nature of the host material. Such bonds must be highly transparent at the laser wavelength as well as pump wavelengths. A refractive index of the undoped optical medium and the bond are preferably closely matched to that of the laser gain medium. Examples of optical contacting followed by heat treatment are described in the U.S. Pat. Nos. 5,441,803, 5,563,899, and 5,846,638 by Helmuth Meissner. Optical medium of this type may be obtained from Onyx Optics in Dublin, Calif. If the host medium is optical glass, doped and undoped sections may be readily attached by fusion bonding produced by casting. This process is available from Kigre Inc. in Hilton Head, S.C. If the host material is in ceramic form, such a bond may be produced during a sintering process. This may be referred to as “co-sintering.” An example of such a process is available from Konoshima Chemical Company LTD of Kagawa, Japan.

“LGM assembly” may refer to an assembly comprising at least one component made of LGM material made of a doped optical medium. In addition, the LGM assembly may have reflective, antireflective, and/or dichroic coatings as appropriate for operation as an amplifier of laser radiation.

“Optical aperture” may refer to a maximum transverse dimension of a laser beam, which can be received, amplified, and transmitted by LGM. The term “aperture” used herein may be synonymous to the one used in optics, such as the diameter of the objective of a telescope or other optical instrument.

“Diode bar” may refer to a source of optical radiation suitable for pumping a laser gain medium to a laser transition comprising an array of semiconductor lasers comprising one or more diodes. The diodes may be mounted in a common substrate and placed on a heat exchanger.

“Diode stack” may refer to a plurality of diode bars arranged in a stack.

Selected embodiments of the present invention will now be explained With reference to the Figures. In the Figures, identical components are provided with identical reference symbols in one or more of the Figures. It will be apparent to those skilled in the art from this disclosure that the following descriptions of the embodiments of the present invention are merely exemplary in nature and are in no way intended to limit the invention, its application, or uses.

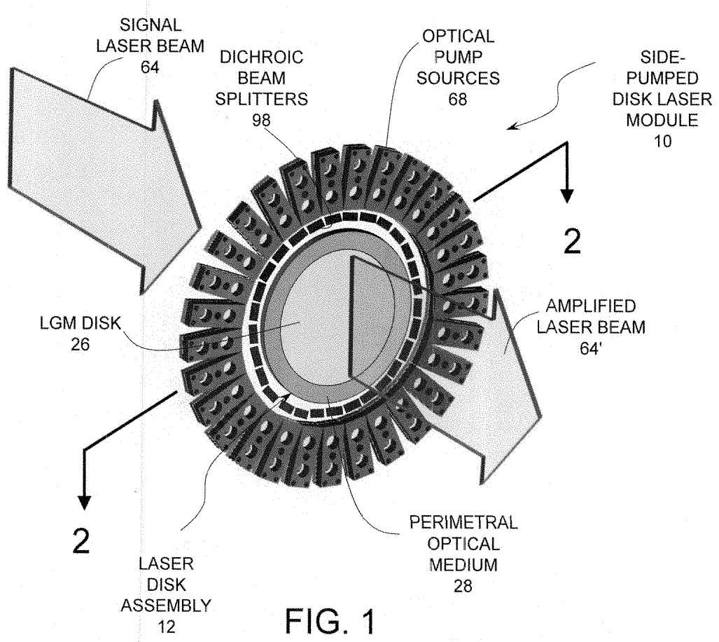

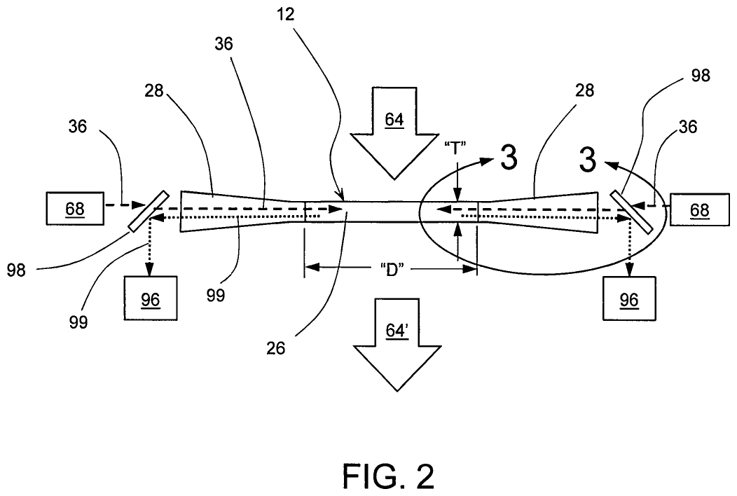

Referring to FIGS. 1 and 2, there is shown one preferred embodiment of a side-pumped disk laser module 10 in accordance with a preferred embodiment of the present invention. The module 10 generally comprises a laser disk assembly 12, optical pump sources 68, dichroic beam splitters 98, and ASE absorbers 96.

The laser disk assembly 12 further comprises a LGM disk 26 and a perimetral optical medium 28. The material of the LGM disk 26 is made of a suitable solid-state LGM such as, but not limited to, neodymium-doped yttrium-aluminum garnet (Nd:YAG), ytterbium doped-yttrium aluminum garnet (Yb:YAG), thulium-doped lutetium sesquioxide (Tm:Lu₂O₃), or neodymium-doped glass (Nd:Glass) as stated above. The perimetral optical medium 28 is made of suitable undoped optical medium, which is preferably (but not necessarily) the same as the host medium used in the LGM disk 26 but without the dopant laser ions. The perimetral optical medium 28 is attached to the peripheral edge of the LGM disk 26 by fusion bond, diffusion bond, casting, co-sintering, and optical contacting followed by heat treatment as described above or any other suitable means.

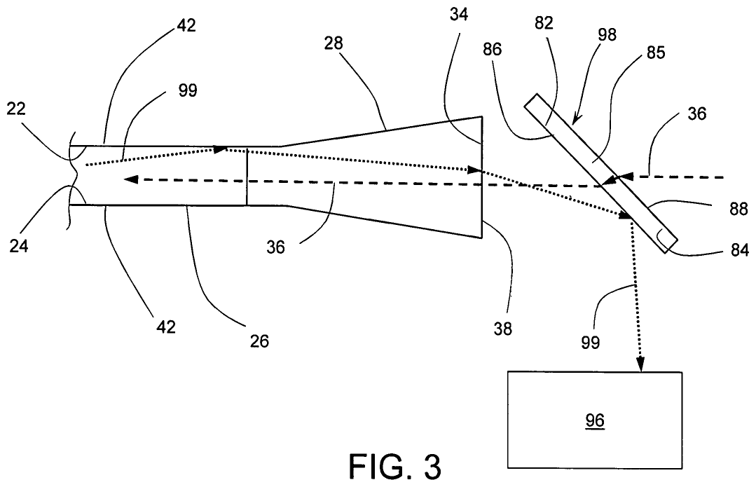

Referring now to FIGS. 2 and 3, the LGM disk 26 has two planar, mutually parallel surfaces, a first surface 22 and a second surface 24, both being ground flat and polished to optical quality, and both being equipped with optical coatings having very reflectivity at the laser wavelength. Such coatings are also known as “antireflective coatings.” The shape of the LGM disk 26 may vary widely but in one preferred form comprises a circular disk with a diameter “D” several times greater than its thickness “T”, as indicated in FIG. 2. Typically, LGM disk 26 may have a thickness “T” ranging approximately from about 0.1 millimeter to about 10 millimeters and a diameter “D” ranging from about 10 millimeters to about 300 millimeters. The diameter “D” may define the optical aperture of the disk laser module 10 indicated in FIG. 1. The LGM disk 26 could just as readily be formed in other various shapes such as (but not limited to) polygonal, circular, or elliptical shapes if desired. Furthermore, while the use of the term “disk” is used herein to reference this component, it will be appreciated that the LGM disk 26 may take other forms which might not be viewed, strictly speaking, as a “disk”. In a preferred embodiment, the aspect ratio, T/D, would range from approximately 10 to 30.

Referring now to FIGS. 1, 2, and 3 the optical pump sources 68, dichroic beam splitters 98, and the ASE absorbers 96 are positioned around the perimetral surface (aka side or edge) 34 of the laser disk assembly 12. Each optical pump source 68 is arranged for directing optical pump radiation through its respective dichroic beam splitter 98 into the perimetral surface 34 of the laser disk assembly 12. The optical pump sources 68 may be a laser diode bar, laser diode stack, or any other optical source for generation of optical pump radiation 36 (dashed line) suitable for pumping the laser disk assembly 12. Optical pump radiation produced by the optical pump source 68 may have a “fast axis divergence.”

Each dichroic beam splitter 98 is installed between its respective optical pump source 68 and the perimetral surface 34 of the laser disk assembly 12. Referring now to FIG. 3, the dichroic beam splitter 98 may generally comprise a thin and flat substrate 85 having a large surface 82 generally facing the laser disk assembly 12 and a large surface 84 generally facing the optical pump source 68. The substrate 85 may be fabricated from an optical material being highly transmissive at both the wavelength of the optical pump radiation 36 and the wavelength of the ASE radiation 99. Examples of materials be suitable for fabrication of the substrate 85 may include but are not limited to optical glass, fused silica, sapphire, and YAG. The surface 82 may be equipped with a dichroic coating 86, which is highly transmissive at the wavelength of the optical pump radiation 36 and highly reflective in the wavelength band of the ASE radiation 99 at the deployed angle of incidence. The surface 84 may be equipped with an optical coating 88 that is antireflective at the wavelength of the optical pump radiation 36 and the deployed angle of incidence. Preferably, the dichroic beam splitter 98 is deployed at an angle theta of approximately 45 degrees with respect to the direction of propagation of the optical pump radiation 36. The angle of the dichroic beam splitter 98 could just as readily be other than 45 degrees if desired, such as 10 degrees to 80 degrees. Preferably, the angle of the dichroic beam is selected so that the ASE radiation 99 is reflected and steered onto the absorber 96.

The perimetral surface 34 of the laser disk assembly 12 for receiving optical pump radiation 36 from the optical pump sources 68 is equipped with a dielectric coating 38 that is antireflective at both the wavelength of the optical pump radiation 36 and the wavelength range of the ASE radiation (dotted line) 99.

The ASE absorber 96 is a component conducive to a very high (preferably nearly total) absorption of the ASE radiation 99. For this purpose, its surface may be equipped with a coating that is highly absorbing at the ASE wavelengths. Absorption of the ASE radiation results in generation of heat. Preferably, the ASE absorber 97 is made of material having high thermal conductivity and configures to dissipate the heat generated therein. Suitable heat dissipation may be attained by thermal conduction and/or by active cooling with a fluid flow.

In operation, the optical pump sources 68 generate optical pump radiation 36, which is directed through the dichroic beam splitters 98 into the surface 34 of the perimetral optical medium 28 of the laser disk assembly 12. Because the dichroic beam splitter 98 is highly transmissive at the optical pump wavelength, the optical pump radiation 36 passes through dichroic beam splitter 98 generally unaffected by it. The perimetral optical medium 28 receives the optical pump radiation 36 through the surface 34, homogenizes it, and channels it into the LGM disk 26. Upon entering LGM disk 26, optical pump radiation 36 is channeled in a direction generally parallel to the surfaces 22 and 24 by multiple internal reflections therefrom. During the passage through the LGM disk 26, the optical pump radiation 36 is gradually absorbed by the dopant laser ions and pumps them to a laser transition, thus developing optical gain. This enables the LGM disk 26 to serve as an amplifier of coherent optical radiation. A signal laser beam 64, having a diameter slightly smaller than the optical aperture dimension “D”, is directed into the LGM disk 26 at a generally normal incidence through the first surface 22, is amplified while passing through the LGM disk 26, and exits as an amplified beam 64′ through the second surface 24 at a generally normal incidence to it. The angle of incidence of the signal laser beam 64 could just as readily be other than normal if desired. Waste heat dissipated within the laser gain medium 26 is conducted to the first surface 22 and the second surface 24. where it may be removed by a flow of gas as taught by J. Vetrovec in the U.S. Pat. No. 7,200,161 issued on Apr. 3, 2007, issued on Apr. 3, 2007, the entire disclosure of which is incorporated herein by reference.

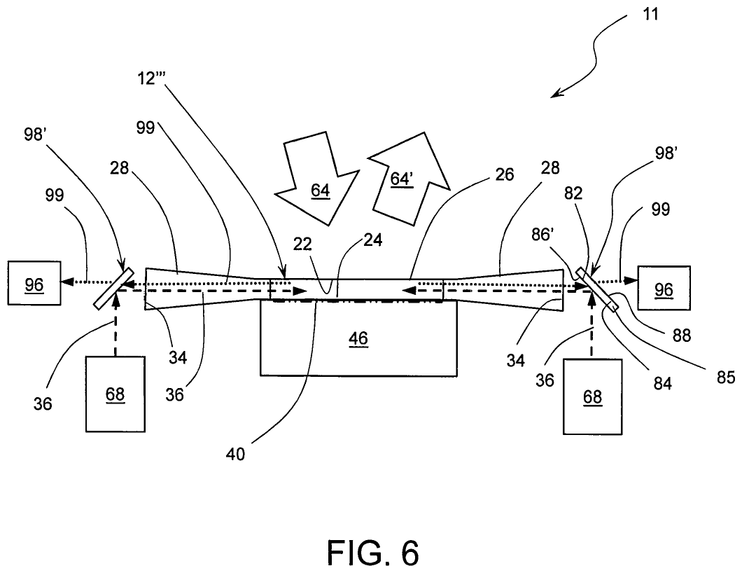

ASE radiation 99 originating in the LGM disk 26 is largely confined to between the large faces of the laser disk assembly 12 by a total internal reflection (TIR) and generally streams out radially toward the dichroic beam splitters 98. Because the beam splitter 98 is highly reflective at the ASE wavelengths, the ASE radiation 99 emanating from the perimetral surface 34 of the laser disk assembly 12 is reflected by the dichroic beam splitter 98 and directed away from the optical axis of the pump radiation 36. In particular, ASE radiation 99 is reflected by the dichroic beam splitter 98 and onto ASE absorbers 96 where the ASE radiation is safely neutralized As a result, 1) the optical pump sources 68 are protected from optical load by the ASE radiation 99. In addition, a possible reflection of the ASE radiation 99 from the surfaces of the optical pump source 68 into the laser disk assembly 12 is prevented. To further mitigate ASE, an ASE absorbing coating may be applied to the large surfaces of the laser disk assembly 12 outside the diameter “D.” The ASE absorbers 96 can be incorporated into a housing (not shown) which serves as, among other things, a mount for the disk and pump diodes. Alternatively, the ASE absorbers 96 could be integrated with Meat sink 46 described in more detail below with respect to FIG. 6.

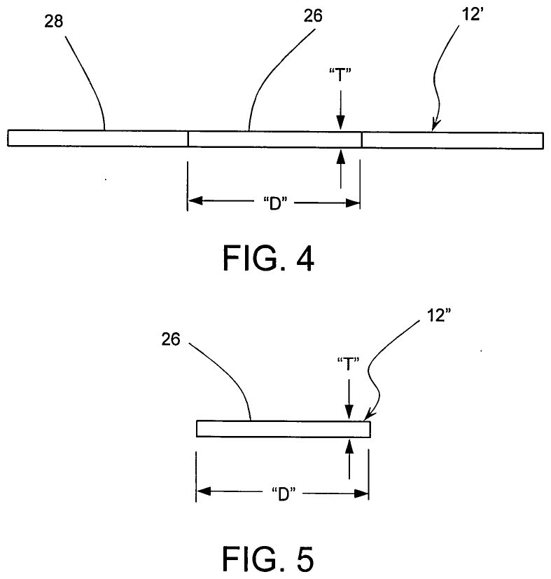

Referring now to FIG. 4, there is shown a cross-sectional view of an alternative laser disk assembly 12′ with an alternative perimetral optical medium 28 being flat and having the same, or nearly the same, thickness “T” as the LGM disk 26. The alternative laser disk assembly 12′ is substantially less complex to fabricate than the laser disk assembly 12 of FIG. 2 where the perimetral optical medium 28 has a tapered portion.

Referring now to FIG. 5, there is shown a cross-sectional view of an alternative laser disk assembly 12″ comprising solely of the LGM disk 26 and having no perimetral optical medium. In this case, the peripheral surfaces of the LGM disk 26 are equipped with an optical coating 38″ that is high transmissive (e.g., antireflective) at both the wavelength of the optical pump radiation and the wavelength of the ASE radiation.

An alternative preferred embodiment of the side-pumped disk laser module of the present invention is suitable for operation at increased optical power density while being conducive to compact packaging. Referring now to FIG. 6, there is shown a cross-sectional view of a side-pumped disk laser module 11 in accordance with the alternative embodiment of the subject invention comprising a laser disk assembly 12′″, optical pump sources 68, dichroic beam splitters 98′, heat sink 46, and ASE absorbers 96. The laser disk assembly 12′″ is similar to the laser disk assembly 12 shown in FIG. 2 except that the second surface 24 of the of the LGM disk 26 is now equipped with an optical coating 40 (dashed and dotted line) having high reflectivity at the laser wavelength. The coating 40 may be further arranged to selectively absorb grazing incidence rays at the wavelength of the ASE radiation 99 but not at the wavelength of the optical pump radiation 36. The first surface 22 of the of the LGM disk 26 is still coated with an optical coating that is antireflective at the laser wavelength.

The heat sink 46 is made of a material with good thermal conductivity, preferably copper, tungsten, molybdenum, sapphire, silicon carbide, silicon, but other materials with good thermal conductivity and suitable for active cooling can be used. The material of the heat sink 46 can also be chosen to have a coefficient of thermal expansion close to that of the LGM disk 26. The heat sink 46 is attached to second surface 24 of the LGM disk 26 via the reflective coating 40 and in a good thermal communication therewith. The interface surface of the heat sink 46 is preferably machined to optical flatness to properly mate with the second surface 24 of the LGM disk 26. The thickness of the heat sink 46 is preferably chosen to provide mechanical rigidity necessary to ensure that the interface surface remains optically flat under operational conditions. The heat sink 46 may be attached to the LGM disk 26 by a variety of suitable techniques including but not limited to optical contacting, adhesive bonding, and soldering.

The dichroic beam splitter 98′ may generally comprise a thin and flat substrate 85 having a large surface 82 generally facing the laser disk assembly 12 and a large surface 84 generally facing the ASE absorber 96. The surface 82 may be equipped with a dichroic coating 86′, which is highly reflective at the wavelength of the optical pump radiation 36 and highly transmissive in the wavelength band of the ASE radiation 99 at the deployed angle of incidence. The surface 84 may be equipped with an optical coating that is antireflective at the wavelength of the optical pump radiation 36 and the deployed angle of incidence.

Preferably, the dichroic beam splitter 98′ is deployed at an angle, which may be approximately 45 degrees with respect to the direction of propagation of the ASE radiation 99. The angle of the dichroic beam splitter 98′ could just as readily be other than 45 degrees if desired. The optical pump sources 68 are positioned around and close to the heat sink 46. Each optical pump sources 68 is arranged to direct optical pump radiation 36 onto its respective dichroic beam splitter 98′. The deployment angle of the dichroic beam splitter 98 is arranged to be such that the optical pump radiation 36 is reflected by it and directed into the surface 34 of the perimetral optical medium.

In operation, the optical pump sources 68 generate optical pump radiation 36, which is directed onto the dichroic beam splitters 98′ and reflected by them into the surface 34 of the perimetral optical medium 28 of the laser disk assembly 12′. The perimetral optical medium 28 receives the optical pump radiation 36 through the surface 34, homogenizes it, and channels it into the LGM disk 26 where it is largely absorbed by the laser ions and pumps them to develop optical gain, thus enabling the LGM disk 26 to serve as an amplifier of coherent optical radiation. A signal laser beam 64, having a diameter slightly smaller than the optical aperture dimension “D”, is directed into the LGM disk 26 at a generally normal angle of incidence through the first surface 22, is amplified while passing through the LGM disk 26, is reflected from the coating 40 on the second surface 24, is amplified again while passing through the LGM disk 26 in the reverse direction, and exits as an amplified beam 64′ through the first surface 22 at a generally normal angle of incidence to it.

Because the dichroic beam splitter 98′ is highly transmissive at the ASE wavelengths, the ASE radiation 99 emanating from the perimetral surface 34 of the laser disk assembly 12′ is not significantly affected by the dichroic beam splitter 98′. In particular, ASE radiation 99 passes through the dichroic beam splitter 98′ and onto ASE absorbers 96 where the ASE radiation is safely neutralized. Again, the optical pump sources 68 are protected from optical load by the ASE radiation 99. In addition, a possible reflection of the ASE radiation 99 from the surfaces of the optical pump sources 68 into the laser disk assembly 12′ is prevented.

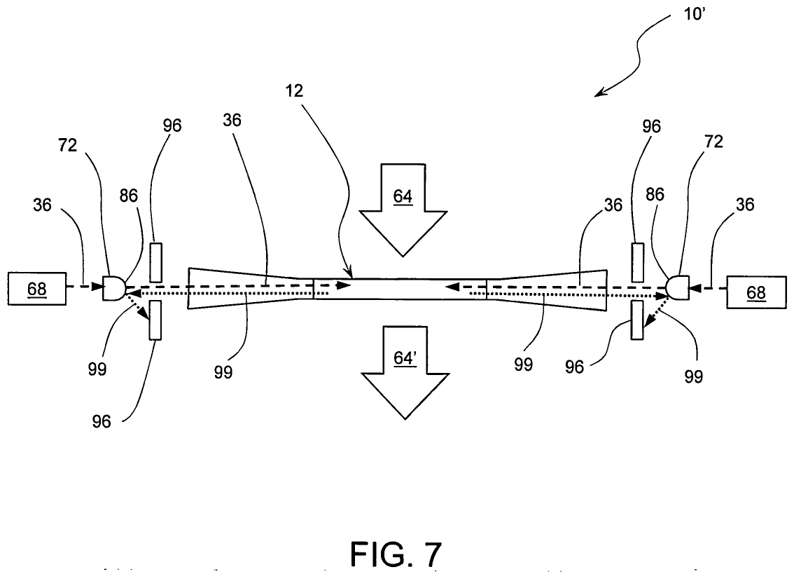

Yet another alternative preferred embodiment of the side-pumped disk laser module of the present invention is suitable for even more compact packaging by integrating the function of the dichroic bream splitter with a collimating lens for the optical pump radiation. Referring now to FIG. 7, there is shown a cross-sectional view of a side-pumped disk laser module 10′ comprising a laser disk assembly 12, optical pump sources 68, collimating lenses 72, and ASE absorbers 96. Collimating lenses such as the lens 72 are frequently used with optical pump sources to collimate the optical pump radiation before providing it to the LGM. A collimating lens 72 may be integrated with the optical pimp source 68. Such an integrated collimating lens may be known in the art as a microlens, a micro-collimator, or a fast axis collimator. The laser disk assembly 12 is same as the laser disk assembly 12 shown in FIG. 2. The collimating lens 72 is placed between the laser disk assembly 12 and the optical pump source 68. The collimating lens 72 has a convex surface facing away from the optical pump source and toward the laser disk assembly 12. The convex surface is equipped with a dichroic coating, that is transmissive at the wavelength of, the optical pump source and highly reflective the wavelength band of the ASE radiation. In operation, the ASE radiation 99 impinging onto the convex surface of the lens is reflected in a broad range of angles onto the absorber 96, which made be divided into two units as shown in FIG. 7, thereby forming a passage therebetween. The optical pump radiation 36 and the ASE radiation 99 may be transported through the resulting passage.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

The term “configured” as used herein to describe a component, section or part of a device includes hardware and/or software that is constructed and/or programmed to carry out the desired function.

The term “suitable”, as used herein, means having characteristics that are sufficient to produce a desired result. Suitability for the intended purpose can be determined by one of ordinary skill in the art using only routine experimentation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof. Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Moreover, terms that are expressed as “means-plus function” in the claims should include any Structure that can be utilized to carry out the function of that part of the present invention. Similarly, the claims are not to be interpreted as indicating a “step plus function” relationship unless, the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as: all permutations and combinations of the subject matter set forth herein and are not limited except as by the appended claims or other claim having adequate support in the discussion and figures herein.

What is claimed is:

1. A side-pumped solid-state laser module for amplification of laser radiation, comprising:
a. a laser gain medium having a pair of generally parallel surfaces and forming a disc-like shape; the pair of surfaces being adapted for at least one of the surfaces to receive and transmit laser radiation;
b. at least one perimetral optical medium disposed adjacent a peripheral edge of said laser gain medium and in optical communication with the laser gain medium;
c. an optical pump source for providing optical pump radiation into said perimetral optical medium generally parallel to the generally parallel surfaces; and the perimetral optical medium operating to transport said optical pump radiation into the laser gain medium and to pump the laser gain medium to develop optical gain;
d. a dichroic beam splitter disposed between said optical pump radiation source and the perimetral optical medium;
e. an amplified spontaneous emission (ASE) absorber disposed to receive ASE emanating from the perimetral optical medium.

2. The side-pumped solid-state laser module of claim 1, further comprising a coating on the dichroic beam splitter wherein the coating transmits optical pump radiation, and reflects ASE onto the ASE absorber.

3. The side-pumped solid-state laser module of claim 1, further comprising a coating on the dichroic beam splitter wherein the coating transmits ASE onto the ASE absorber and reflects optical pump radiation from the optical pump source into the perimetral optical medium.

4. The side-pumped solid-state laser module of claim 1, further comprising:
a. a heat sink attached to one of the generally parallel surfaces with a reflective coating disposed between the heat sink and the one generally parallel surface.

5. The side-pumped solid-state laser module of claim 1, further comprising a lens for collimating said optical pump radiation and the dichroic beam splitter being integrated with the lens.

6. The side-pumped solid-state laser module of claim 1, further comprising a lens for collimating said optical pump radiation; said lens having a convex surface; and said coating being installed on said convex surface.

7. A side-pumped solid-state laser module for amplification of laser radiation, comprising:
a. a laser gain medium having a pair of generally parallel surfaces and forming a disc-like shape; the pair of surfaces being adapted for at least one of the surfaces to receive and transmit laser radiation;
b. a source of optical pump radiation for directing optical pump radiation into the laser gain medium generally parallel to the generally parallel surfaces; and to pump the laser gain medium to develop optical gain;
c. a dichroic beam splitter disposed between said optical pump radiation source and the laser gain medium;
d. an amplified spontaneous emission (ASE) absorber disposed to receive ASE emanating from the laser gain medium.

8. The side-pumped solid-state laser module of claim 7, further comprising a coating on the dichroic beam splitter wherein the coating transmits optical pump radiation, and reflects ASE.

9. The side-pumped solid-state laser module of claim 7, further comprising a coating on the dichroic beam splitter wherein the coating transmits ASE and reflects optical pump radiation.

10. The side-pumped solid-state laser module of claim 7, further comprising:
a. a heat sink attached to one of the generally parallel surfaces with a reflective coating disposed between the heat sink and the one generally parallel surface.

11. The side-pumped solid-state laser module of claim 7, further comprising: a doped laser medium.

12. The side-pumped solid-state laser module of claim 7 wherein the aspect ratio of the laser gain medium is between 10 and 30.

13. A solid-state laser module for amplification of laser radiation comprising: a laser gain medium disk assembly having a perimetral edge surface, an optical pump source for generation of optical pump radiation, an ASE absorber, and a dichroic beam splitter disposed between said optical pump source and said perimetral edge surface; laser gain medium disk assembly adapted for generating optical gain at a laser wavelength and ASE radiation; said optical pump source adapted for directing optical pump radiation into said perimetral edge surface; said dichroic beam splitter adapted for transmitting said optical pump from said optical pump source into the perimetral edge surface; said dichroic beam splitter adapted for reflecting ASE radiation from said laser gain medium disk assembly onto said ASE absorber.

14. The solid-state laser module of claim 13 further comprising a lens adapted for collimating said optical pump radiation; said lens disposed between said optical pump source and said perimetral edge surface; said lens having a convex surface; wherein said dichroic beam splitter is formed on said convex surface of said lens.

15. The side-pumped solid-state laser module of claim 13, further comprising:
a. a heat sink attached to one of the generally parallel surfaces with a reflective coating disposed between the heat sink and the one generally parallel surface.

16. The side-pumped solid-state laser module of claim 14 wherein said lens is integrated with said optical pump source for fast axis collimation of the optical pump radiation.

17. A solid-state laser module for amplification of laser radiation comprising: a laser gain medium disk assembly having a perimetral edge surface, an optical pump source for generation of optical pump radiation, an ASE absorber, and a dichroic beam splitter disposed between said optical pump source and said perimetral edge surface; laser gain medium disk assembly adapted for generating optical gain at a laser wavelength and ASE radiation; said optical pump source adapted for directing optical pump radiation into said perimetral edge surface via reflection from said dichroic beam splitter; said dichroic beam splitter adapted for reflecting said optical pump from said optical pump source into the perimetral edge surface; said dichroic beam splitter adapted for transmitting ASE radiation from said laser gain medium disk assembly onto said ASE absorber.

18. The solid-state laser module of claim 17 further comprising a lens adapted for collimating said optical pump radiation; said lens disposed between said optical pump source and said perimetral edge surface; said lens having a convex surface; wherein said dichroic beam splitter is formed on said convex surface of said lens.

19. The side-pumped solid-state laser module of claim 17, further comprising:
a. a heat sink attached to one of the generally parallel surfaces with a reflective coating disposed between the heat sink and the one generally parallel surface.

20. The side-pumped solid-state laser module of claim 18 wherein said lens is integrated with said optical pump source for fast axis collimation of the optical pump radiation.
